(19) United States
(12) Patent Application Publication
(10) Pub. No.: US 2015/0363116 A1
(43) Pub. Date: Dec. 17, 2015

(54) MEMORY CONTROLLER POWER MANAGEMENT BASED ON LATENCY

(71) Applicant: Advanced Micro Devices, Inc., Sunnyvale, CA (US)

(72) Inventors: Sibi Govindan, Austin, TX (US); Sadagopan Srinivasan, Austin, TX (US); Lloyd Bircher, Austin, TX (US)

(21) Appl. No.: 14/302,964

(22) Filed: Jun. 12, 2014

(51) Int. Cl. G06F 3/06; G06F 1/32; G06F 1/26

(52) U.S. Cl. CPC G06F 3/0611; G06F 3/0653; G06F 3/0673; G06F 1/26; G06F 1/3275

(57) ABSTRACT

A processor monitors, directly or indirectly, the amount of time it takes for the memory controller to respond to one or more memory access requests. When this memory access latency indicates that a memory latency tolerance of a program thread has been exceeded, the processor can apportion additional power to the memory controller, thereby increasing the speed with which the memory controller can process memory access requests.

### BACKGROUND

1. Field of the Disclosure

The present disclosure relates generally to processors and more particularly to power management for processors.

2. Description of the Related Art

For many electronic devices having a processor, such as those powered by a battery, it is desirable for the processor to consume as little power as possible while still meeting at least a minimum performance target. Accordingly, the processor is typically assigned a power budget, represented by a voltage or other characteristic representing power applied to the processor. The processor apportions its power budget among its various modules, such as processor cores, memory controllers, and the like, by setting the voltage or other characteristic applied to each module so that the processor meets at least its minimum performance target. However, each module may not require its apportioned power in all circumstances. For example, a module that has no operations to perform may not require its apportioned power for a brief period of time, allowing the processor to temporarily reassign some of the module's apportioned power to a different module, improving overall processor performance.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processor that can apportion power to a memory controller based on the memory access latency in accordance with some embodiments.

FIG. 2 is a diagram illustrating the apportionment of power to the memory controller of FIG. 1 based on a program thread's memory latency tolerance in accordance with some embodiments.

FIG. 3 is a diagram illustrating the apportionment of power to the memory controller of FIG. 1 based on a program thread's memory latency tolerance and an instruction processing rate in accordance with some embodiments.

FIG. 4 is a diagram illustrating the apportionment of power to the memory controller of FIG. 1 based on a program thread's memory latency tolerance relative to multiple thresholds in accordance with some embodiments.

FIG. 5 is a flow diagram illustrating a method of apportioning power to a memory controller of a processor based on a program thread's memory latency tolerance in accordance with some embodiments.

FIG. 6 is a flow diagram illustrating a method for designing and fabricating an integrated circuit device implementing at least a portion of a component of a processing system in accordance with some embodiments.

### DETAILED DESCRIPTION OF EMBODIMENT(S)

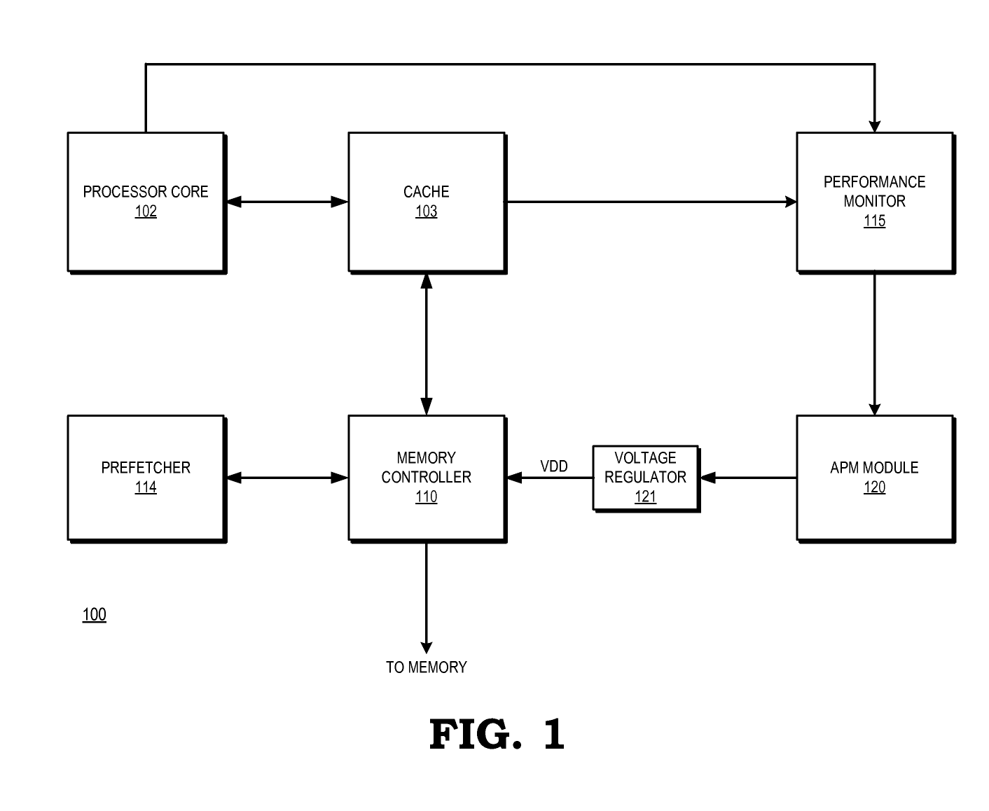

FIGS. 1-6 illustrate techniques for apportioning power to a memory controller of a processor based on a program thread's memory latency tolerance. The processor monitors, directly or indirectly, the memory latency for the program thread by monitoring amount of time it takes for the memory controller to respond to one or more memory access requests. When the program thread's memory latency tolerance is exceeded, as indicated by one or more performance characteristics such as a cache miss rate, the processor can apportion additional power to the memory controller, thereby increasing the speed with which the memory controller can process memory access requests. When the memory latency tolerance for the program thread is not exceeded, the processor can reduce the amount of power apportioned to the memory controller. The processor thus improves performance for execution of the program thread while still conserving power.

To illustrate, in some embodiments the processor detects cache misses by monitoring memory access requests that are provided to a memory controller. For example, a cache miss may cause a memory access request that was provided to a cache to be transferred to the memory controller. When the cache miss rate (CMR) for the cache exceeds a threshold, this indicates that the memory controller likely has a relatively large number of memory access requests to process, which may delay processing of an executing program thread's memory accesses and increase the memory latency for the executing program thread such that the memory latency tolerance for the thread is exceeded. In response, an application power management (APM) module of the processor can increase a power voltage applied to the memory controller. This increased power voltage allows the transistors of the memory controller to switch more quickly, increasing the overall speed with which the memory controller can process its pending memory access requests. Accordingly, increasing the power supplied to the memory controller reduces the memory access latency when there are a relatively large number of memory access requests to be processed. When there are relatively few memory access requests to process at the memory controller, as indicated by the CMR, the APM module can reduce the power voltage applied to the memory controller, thereby conserving power.

As used herein, “memory latency” refers to the amount of time it takes for memory access requests to complete execution. In some embodiments, the memory latency for a particular memory access request is dependent on a number of factors, including the speed with which the memory access request can be processed at a memory controller. Further, because increasing power to the memory controller allows the memory controller to process memory access requests more quickly, increasing power to the memory controller reduces memory latency.

As used herein “memory latency tolerance” refers to the sensitivity of a program thread to accesses to a designated level of a memory hierarchy, such as an external RAM connected to a processor. The sensitivity can be expressed as the time it takes or is expected to take to execute at least a portion of the program thread. In some embodiments, the processor can measure whether the memory access tolerance of a program thread has been exceeded by measuring the amount of time it takes to process a memory access request at a memory controller, using a counter or other timing mechanism. In some embodiments, the processor can measure whether the memory latency tolerance for an executing program thread has been exceeded indirectly, using a performance indicator such as a cache miss rate, a number of memory access requests received at the memory controller, or other performance indicator.

As described herein, the processor can apportion power to the memory controller based on the memory access latency. For purposes of description, the embodiments described herein employ a processor that apportions power by changing the magnitude of one or more reference voltages (sometimes referred to as VDD) of the memory controller. It will be appreciated that in some embodiments the processor may apportion power in other ways, such as by changing an amount of current applied to one or more nodes of the memory controller.

FIG. 1 illustrates a processor 100 that can apportion power to a memory controller in accordance with some embodiments. The illustrated processor 100 includes a processor core 102 that can be, for example, a central processing unit (CPU) core based on an x86 instruction set architecture (ISA), an ARM ISA, and the like. The processor 100 can implement a plurality of such processor cores, and can further implement processor cores designed or configured to carry out specialized operations, such as one or more graphics processing unit (GPU) cores to perform graphics operations on behalf of the processor 100. The processor 100 can be implemented in any of a variety of electronic devices, such as a notebook computer, desktop computer, tablet computer, server, computing-enabled cellular phone, personal digital assistant (PDA), set-top box, and the like.

The processor core 102 executes sets of instructions, referred to as program threads, to perform tasks on behalf of an electronic device. In the course of executing a program thread, the processor core 102 can generate requests, referred to as memory access requests, which represent demands for data not stored at internal registers of the processor core 102. The memory access requests can include store operations, each store operation representing a demand to store corresponding data for subsequent use, and load operations, each load operation representing a demand to retrieve stored data for use by the processor core 102.

In the depicted example, the processor 100 includes a cache 103 that includes a set of entries, referred to as cache lines, wherein each cache line stores corresponding data. Each line is associated with a memory address that identifies the data it stores. In response to a memory access request, the cache 103 identifies whether it includes a line that stores data identified by the memory address of the memory access request. If so, the cache 103 indicates a cache hit and satisfies the memory access request, either by providing the data (in the case of a load operation) or by storing data associated with the memory access request (in the case of a store operation). If the cache 103 does not include a line that stores data identified by the memory address of the memory access request, it indicates a cache miss and provides the memory access request to the memory controller 110. As described further below, the memory controller 110 satisfies the memory access request by retrieving the data associated with the memory address from system memory (not shown) and providing the retrieved data to the cache 103. In response, the cache 103 stores the data at one of its lines, wherein the line is selected based on a cache replacement policy. In addition, the cache 103 uses the retrieved data to satisfy the memory access request, as described above.

Although the cache 103 is depicted as a single cache, in some embodiments it represents a hierarchy of different caches. For example, the cache 103 can include a level 1 (L1) cache that is dedicated to the processor core 102, a level 2 (L2) cache that is shared between the processor core 102 and other processor cores (not shown), and one or more additional levels of caches. In response to a memory access request, the cache 103 can successively check each cache in the hierarchy until it locates a cache having a line corresponding to the memory address of the memory access request, indicating individual cache misses or hits at each level. If none of the caches include a line corresponding to the memory address of the memory access request, the cache 103 provides the memory access request to the memory controller 110 for satisfaction, as described above.

The memory controller 110 manages the communication of memory access requests to a system memory (not shown) including one or more memory devices, such as random access memory (RAM) modules, flash memory, hard disk drives, and the like, or a combination thereof. Further, the memory controller 110 is configured such that it can buffer multiple memory access requests, and process each request according to a specified arbitration policy. Processing a memory access request can include buffering the memory access request, arbitrating between the memory access requests and other pending memory access requests stored at a buffer, generating the control signaling to communicate the memory access request to one or more of the memory devices of the system memory, buffering data received from the system memory responsive to the memory access request, and communicating the responsive data to the cache 103. In some embodiments, the memory controller 110 is a northbridge that performs additional functions, including managing memory coherency between the cache 103 and other processor caches (not shown), managing communications between processor cores and other system modules, and the like.

The memory controller 110 includes a set of modules composed of transistors and other electronic components not individually illustrated at FIG. 1. These electronic components are supplied power by a reference voltage, designated “VDD.” The behavior of at least some of the electronic components is such that, the higher the magnitude of VDD, the faster that the electronic components can respond to input stimuli. For example, the memory controller 110 can include one or more transistors configured to switch, based on input stimuli (e.g. a voltage at their respective gate electrodes) between conductive and non-conductive state. As the magnitude of VDD increases, the speed with which the one or more transistors can switch between the conductive and non-conductive states increases. Accordingly, the net effect of an increase in the magnitude of VDD is that the memory controller 110 is able to process memory access requests more quickly, reducing memory access latency.

The processor 100 includes a voltage regulator 121 that is configured to set the magnitude of VDD. As described further herein, the processor 100 can control the voltage regulator 121 to adjust VDD in response to the memory access tolerance for a program thread being exceeded, thereby improving overall processing efficiency at the processor 100.

To facilitate monitoring of the memory latency for the program thread, the processor 100 includes a performance monitor 115 that monitors performance information based on operations at the processor core 102, the cache 103, and other modules of the processor 100. The performance monitor 115 includes a set of registers, counters, and other modules to identify and record occurrences of designated events over designated amounts of time. For example, in some embodiments, the performance monitor measures and records the cache miss rate (CMR) at the cache 103. When the cache 103 is a cache hierarchy having multiple caches, the performance monitor 115 can measure and record the CMR at one or more, or at each, of the multiple caches. For example, in some embodiments the performance monitor 115 records the CMR at an L2 cache shared between the processor core 102 and one or more other processor cores. The performance monitor 115 can also measure and record other performance characteristics, such as the instructions-per-cycle (IPC) rate at the processor core 102, the rate at which the memory controller 110 receives memory access requests, the rate at which the memory controller 110 sends data responsive to memory access requests, and the like.

The APM module 120 is a power control module that uses the performance information to adjust the power supplied to one or more modules of the processor 100, including the memory controller 110. In particular, the APM module 120 uses one or more performance measurements recorded at the performance monitor 115, such as CMR, to identify the memory access latency at the memory controller 110. When the performance measurements exceed a corresponding threshold, indicating that the memory access latency has exceeded the memory access latency tolerance for an executing program thread, the APM module 120 causes the voltage regulator 121 to increase the magnitude of VDD, thus increasing the power supplied to the memory controller 110. This increases the speed at which the memory controller 110 processes memory access requests, thereby reducing the memory access latency below the memory access latency tolerance for the program thread. The APM module 120 reduces the magnitude of VDD when the memory access latency falls below the tolerance for the program thread, after a defined amount of time has elapsed after the magnitude of VDD was increased, after a threshold number of memory access requests have been processed at the memory controller 110, or based on one or more other criteria being satisfied.

To illustrate, in the depicted example, the processor 100 includes a prefetcher 114 that monitors memory accesses at the memory controller 110. The prefetcher 114 identifies patterns in the memory accesses and, based on those patterns, issues prefetch requests to the memory controller 110 to load data that is anticipated to be needed soon to the cache 103. Accordingly, as long as the memory access requests issued by the processor core 102 follow the pattern(s) identified by the prefetcher 114, the memory access requests are likely to be satisfied at the cache 103, thus keeping the CMR low. Thus, the number of memory access requests provided to the memory controller 110 is likely to remain low, thereby also keeping memory access latency relatively low. When the processor core 102 issues a number of memory access requests that do not follow the pattern(s) identified by the prefetcher 114, the memory access requests are more likely to be miss at the cache 103, increasing the CMR. The memory access requests that missed at the cache 103 are provided to the memory controller 110, thereby causing the memory access latency to exceed the memory access tolerance for a program thread executing at the processor core 102 because of the increased time it takes the memory controller 110 to process the higher number of memory access requests. Accordingly, when the CMR increases above a given threshold, the memory access latency is likely to exceed the memory latency tolerance for the executing program thread. In response to the CMR exceeding the given threshold, the APM module 120 increases VDD so that the memory controller 110 can process the higher number of memory access requests more quickly, so that the memory latency for the executing thread falls below the memory access latency tolerance for the executing thread.

In some embodiments, the APM module 120 enforces a power management policy for the modules of the processor 100, whereby the power management policy indicates a nominal amount of budgeted power for each module, relative to thermal limits and other physical specifications for the processor 100. The power management policy can also set priorities for different modules of the processor 100, such that the APM module assigns 120 the power supplied to each module based on 1) performance characteristics for each module; and 2) the priority of each module. Thus, for example, if the performance characteristics for two different modules indicate a demand for additional power, the APM module 120 can identify whether the demanded power would cause the processor 100 to exceed an overall power budget and, if so, which of the two modules is to be assigned additional power.

To illustrate via an example, in some embodiments the processor 100 is associated with a power management policy whereby the power requirements of the processor core 102 are given priority over the power requirements of the memory controller 110. In some scenarios, the performance characteristics stored at the performance monitor 115 can indicate that both the processor core 102 and the memory controller 110 can benefit from an increase in supplied power. For example, the CMR can indicate that the memory controller 110 can benefit from an increase in VDD concurrently with the IPC at the processor core 102 indicating that the processor core 102 can benefit from an increase in its supplied power. The APM module 120 first identifies whether the power supplied to the processor core 102 and the power supplied to the memory controller 110 can both be increased without the processor 100 exceeding its overall power budget and, if so, increases the power supplied to each module. If the APM module 120 identifies that increasing the power supplied to both the processor core 102 and the memory controller 110 would cause the overall power budget to be exceeded, the APM module 120 increases the power supplied to the processor core 102, as required by its priority in the power management policy of the processor core 102.

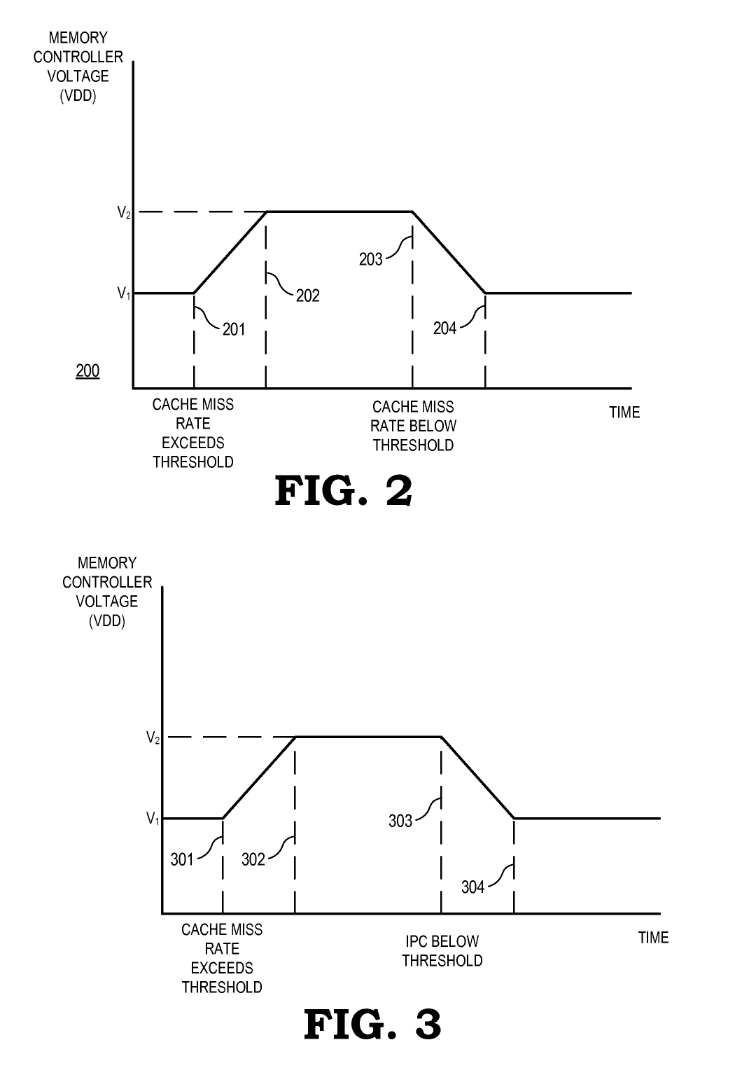

FIG. 2 depicts a diagram 200 illustrating the apportionment of power to the memory controller 110 of FIG. 1 based on an executing program thread's memory latency tolerance in accordance with some embodiments. The x-axis of diagram 200 corresponds to time, while the y-axis corresponds to the magnitude of VDD supplied to the memory controller 110 by the voltage regulator 121. In the illustrated example, at time 201 the APM module 120 identifies, based on information stored at the performance monitor 115, that the CMR at the cache 103 exceeds a threshold, indicating that the memory latency tolerance for an executing program thread likely exceeds a corresponding threshold. Accordingly, the APM module 120 signals the voltage regulator 121 to increase VDD from a nominal magnitude designated “V₁” to an increased magnitude designated “V₂”. At time 202, the magnitude of VDD has increased to V₂, thereby allowing the memory controller 110 to process pending memory access requests more quickly.

At time 203, the APM module 120 identifies that the CMR for the cache 103 has fallen below the threshold, indicating that the memory latency tolerance for the executing program thread has no longer been exceeded. In response, the APM module 120 signals the voltage regulator 121 to decrease the magnitude of VDD from V₂ to V₁. By time 204, the magnitude of VDD has been reduced to V₁, thereby reducing the power consumed by the memory controller 110. Thus, in the illustrated example of FIG. 2, the processor 100 improves the performance of an executing program thread that is sensitive to memory latency by increasing the power supplied to the memory controller 110, but limits the power consumed by the memory controller by only increasing the supplied power when the memory latency tolerance for the program thread has likely been exceeded.

FIG. 3 illustrates a diagram 300 showing the apportionment of power to the memory controller 110 based on a cache miss rate and an instruction processing rate in accordance with some embodiments. The x-axis of diagram 300 corresponds to time, while the y-axis corresponds to the magnitude of VDD supplied to the memory controller 110 by the voltage regulator 121. In the illustrated example, at time 301 the APM module 120 identifies, based on information stored at the performance monitor 115, that the CMR at the cache 103 exceeds a threshold. Accordingly, the APM module 120 signals the voltage regulator 121 to increase VDD from a nominal magnitude designated “V₁” to an increased magnitude designated “V₂”. At time 302, the magnitude of VDD has increased to V₂, thereby allowing the memory controller 110 to process pending memory access requests more quickly.

At time 303, the APM module 120 identifies that an IPC rate at the processor core 102 has fallen below a threshold. The APM module 120 further identifies that supplying additional power while maintaining the magnitude of VDD at V₂ would cause the processor 100 to exceed an overall power budget. Moreover, the APM module 120 identifies, based on a power management policy, that the power needs of the processor core 102 are to be prioritized over the power needs of the memory controller 110. In response, the APM module 120 signals the voltage regulator 121 to decrease the magnitude of VDD from V₂ to V₁. By time 304, the magnitude of VDD has been reduced to V₁, thereby reducing the power consumed by the memory controller 110. Accordingly, the APM module 120 can increase the power supplied to the processor core 102 (e.g., by increasing the magnitude of a voltage supplied to the processor core 102). This allows the processor core 102 to perform instruction processing more quickly, thus reducing its IPC without the processor 100 exceeding its overall power budget.

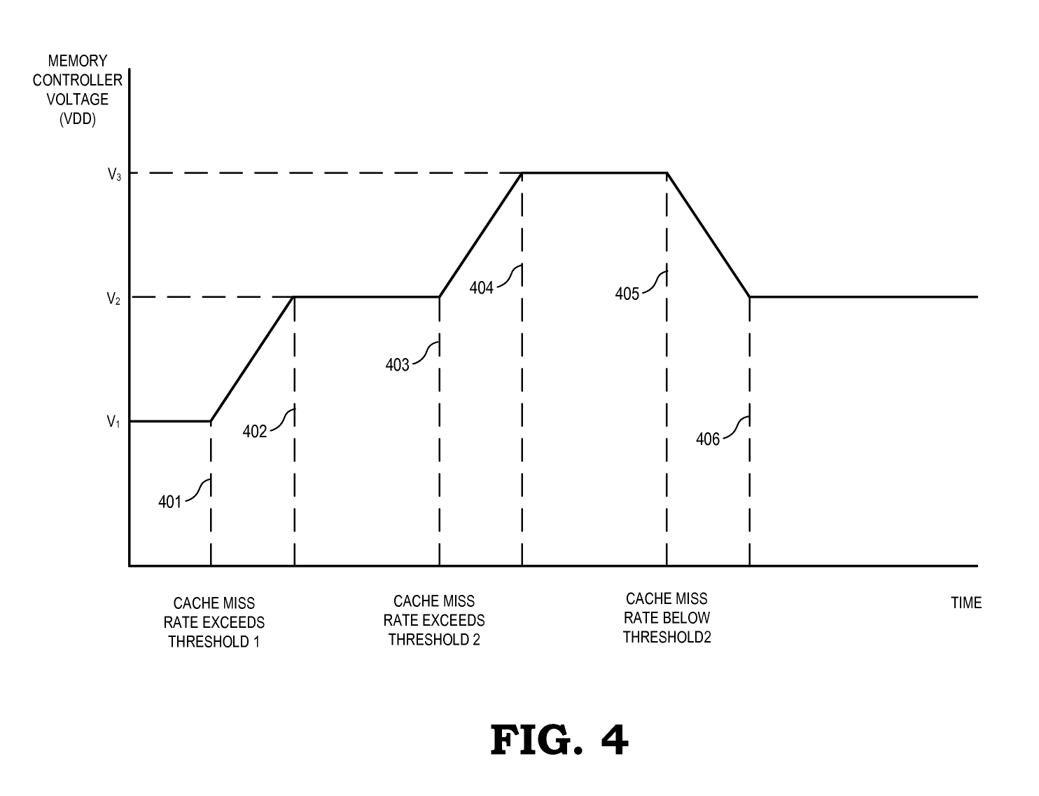

In some embodiments, the APM module 120 can set the magnitude of VDD to any of a number of possible magnitudes based on the relationship of the CMR to corresponding thresholds. When the CMR exceeds one of the thresholds, this indicates that the memory latency tolerance for the executing thread has been exceeded by a corresponding amount. An example is illustrated at FIG. 4, which depicts a diagram 400 showing the apportionment of power to the memory controller 110 based on a cache miss rate relative to multiple thresholds in accordance with some embodiments. The x-axis of diagram 400 corresponds to time, while the y-axis corresponds to the magnitude of VDD supplied to the memory controller 110 by the voltage regulator 121. In the illustrated example, at time 401 the APM module 120 identifies, based on information stored at the performance monitor 115, that the CMR at the cache 103 exceeds a threshold, designated “Threshold 1”, indicating that the memory latency tolerance for an executing program thread has been exceeded by a first amount. Accordingly, the APM module 120 signals the voltage regulator 121 to increase VDD from a nominal magnitude designated “V₁” to an increased magnitude designated “V₂”. At time 402, the magnitude of VDD has increased to V₂, thereby allowing the memory controller 110 to process pending memory access requests more quickly.

At time 403, the APM module 120 identifies that the CMR at the cache 103 exceeds another threshold, designated “Threshold 2”. Threshold 2 is larger than Threshold 1, such that Threshold 2 indicates the memory latency tolerance for the executing program thread has been exceeded by a second amount larger than the first amount corresponding to Threshold 1. Accordingly, the APM module 120 signals the voltage regulator 121 to increase VDD from V₂ to an increased magnitude designated “V₃”. At time 404, the magnitude of VDD has increased to V₃, thereby allowing the memory controller 110 to process pending memory access requests more quickly. At time 405, the APM module 120 identifies that the CMR for the cache 103 has fallen below Threshold 2. In response, the APM module 120 signals the voltage regulator 121 to decrease the magnitude of VDD from V₃ to V₂.

In some embodiments, the APM module 120 can also adjust the VDD voltage based on other memory access characteristics, such as memory bandwidth. For example the performance monitor 115 can monitor and store information indicative of the amount of memory bandwidth required by memory access requests from the cache 103. In response to the information indicating that the amount of memory bandwidth used by the memory access requests exceeds a threshold, the APM module 120 signals the voltage regulator 121 to increase VDD, at time 405, from magnitude V₂ to V₃.

In addition, in some embodiments the APM module can identify that the memory latency tolerance for an executing program thread has been exceeded based on criteria other than, or in addition to, the cache miss rate at the cache 103. For example, in some embodiments, the APM module 120 can identify the memory latency tolerance for an executing program thread based on the number of memory access requests stored at a buffer of the memory controller 110, based on a number of memory access requests received at an interface of the memory controller 110, based on a rate of responses issued by the memory controller 110 to memory access requests, and the like.

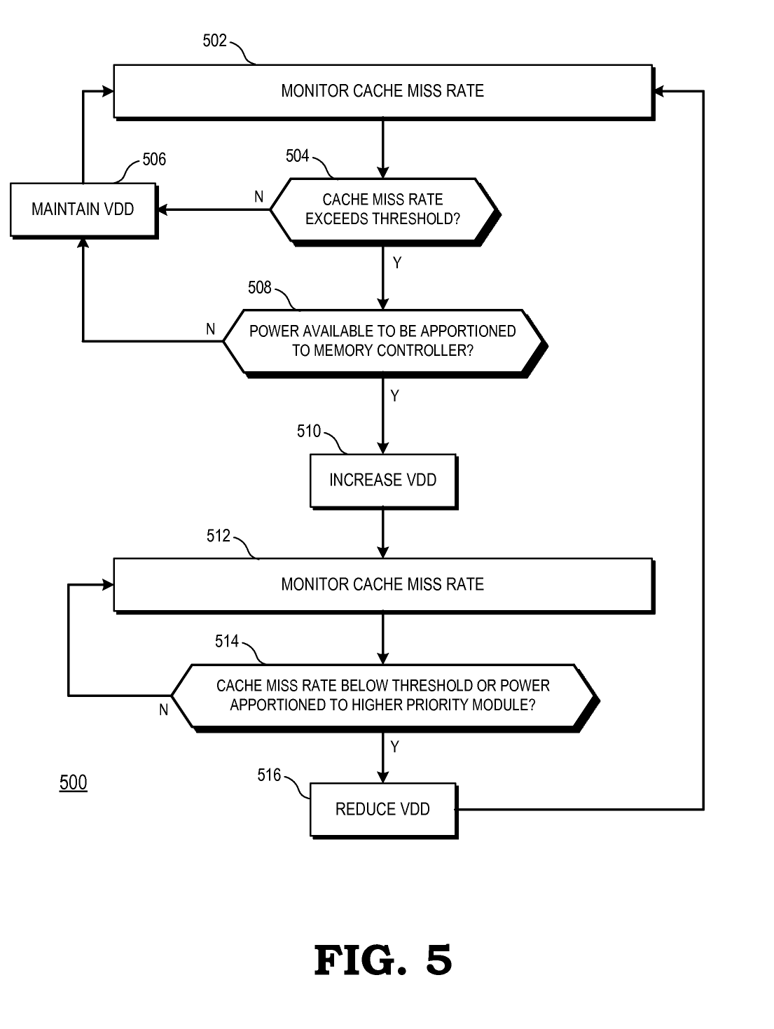

FIG. 5 illustrates a flow diagram of a method 500 of apportioning power to a memory controller of a processor in accordance with some embodiments. For purposes of description, the method is described with respect to an example implementation at the processor 100 of FIG. 1. At block 502, the performance monitor 115 monitors and records the cache miss rate at the cache 103. At block 504, the APM module identifies whether the CMR for the cache 103 exceeds a threshold. If not, the method flow moves to block 506 and the APM module 120 provides no indication to the voltage regulator 121 that VDD is to be changed. Accordingly, the voltage regulator 121 maintains VDD at its nominal magnitude.

If, at block 504, the APM module 120 identifies that the CMR for cache 103 exceeds the magnitude, the method flow moves to block 508 and the APM module 120 identifies whether there is power available, under the power management policy for the processor 100, to be apportioned to the memory controller 110. If not (e.g. because all available power has been apportioned to modules of the processor 100 having higher priority than the memory controller 110 under the power management policy), the method flow moves to block 506 and VDD is maintained by the voltage regulator 121 at its nominal magnitude. If, at block 508, there is power available to be apportioned, the method flow moves to block 510 and the APM module 120 signals the voltage regulator 121 to increase the magnitude of VDD.

The method flow proceeds to block 512 and the performance monitor 115 continues to monitor the CMR for the cache 103. At block 514, the APM module 120 identifies whether 1) the CMR for the cache 103 has fallen below the threshold and 2) whether the additional power apportioned to the memory controller 110 at block 510 is needed by a module of the processor 100 having a higher priority under the power management policy. If neither of these conditions are true, the method flow returns to block 512 and VDD is maintained at the higher magnitude set at block 510. If either of these conditions are true, the method flow moves to block 516 and the APM module 120 signals the voltage regulator 121 to reduce VDD to its nominal magnitude. The method flow returns to block 502.

In some embodiments, the apparatus and techniques described above are implemented in a system comprising one or more integrated circuit (IC) devices (also referred to as integrated circuit packages or microchips). Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

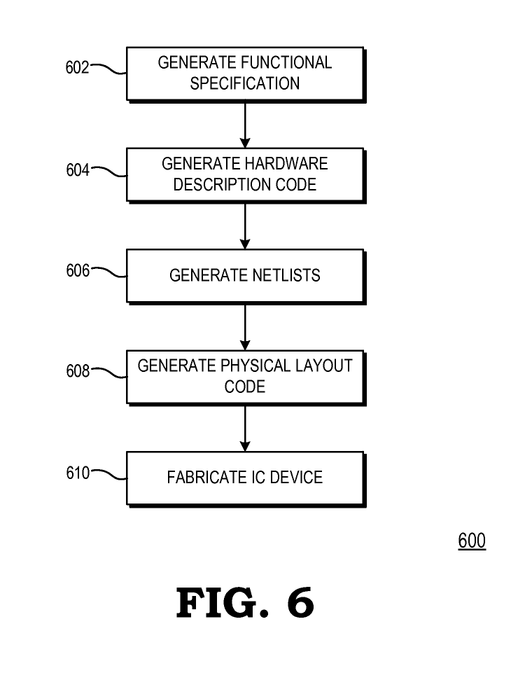

FIG. 6 is a flow diagram illustrating an example method 500 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 602 a functional specification for the IC device is generated. The functional specification (often referred to as a micro architecture specification (MAS)) may be represented by any of a variety of programming languages or modeling languages, including C, C++, SystemC, Simulink, or MATLAB.

At block 604, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 606 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 608, one or more EDA tools use the netlists produced at block 606 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 610, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to identifying that a memory latency tolerance of an executing program thread has been exceeded, increasing power to a memory controller of a processor.

2. The method of claim 1, further comprising:
identifying that the memory latency tolerance of the executing program thread has been exceeded based on a cache miss rate at a cache of the processor.

3. The method of claim 1, further comprising:
in response to identifying that the memory latency tolerance of the executing program thread has not been exceeded, decreasing power to the memory controller of the processor.

4. The method of claim 1, wherein increasing power to the memory controller comprises increasing the power to a first level in response to identifying that the memory latency tolerance of the executing program thread has been exceeded by a first amount, and further comprising:
in response to identifying that the memory latency tolerance of the executing program thread has been exceeded by a second amount, increasing power to the memory controller to a second level.

5. The method of claim 1, wherein increasing power to the memory controller comprises increasing the power to a first level in response to identifying that the memory latency tolerance of the executing program thread has been exceeded by a first amount, and further comprising:
decreasing power to the memory controller from the first level to a second level in response to an instructions-per-cycle rate at a processor core of the processor being below a second threshold.

6. The method of claim 1, further comprising:
in response to identifying that memory access request at the processor requires an amount of memory bandwidth above a threshold, increasing power to the memory controller.

7. The method of claim 1, further comprising
identifying that the memory latency tolerance of the executing program thread has been exceeded based on a number of memory access requests received at the memory controller.

8. The method of claim 1, wherein the memory controller comprises a northbridge.

9. A method, comprising:
in response to a cache miss rate at a processor exceeding a first threshold, increasing power to a memory controller of the processor.

10. The method of claim 9, further comprising:
in response to the cache miss rate falling below the first threshold, decreasing power to the memory controller.

11. The method of claim 9, wherein increasing power to the memory controller comprises increasing power to the memory controller to a first level, and further comprising:
in response to the cache miss rate exceeding a second threshold, increasing power to the memory controller to a second level.

12. The method of claim 9, further comprising:
in response to an instructions-per-cycle rate at a processor core of the processor being below a second threshold, decreasing power to the memory controller.

13. The method of claim 9, further comprising:
decreasing power to the memory controller in response to executing a threshold number of memory access requests at the memory controller after increasing power to the memory controller.

14. A processor comprising:
a memory controller to process memory access requests;
a performance monitor to monitor performance information indicative of whether a memory latency tolerance of a program thread has been exceeded; and
a power control module to increase power to the memory controller in response to the performance monitor indicating the memory latency tolerance of the program thread has been exceeded.

15. The processor of claim 14, wherein the performance monitor indicates the memory latency tolerance of the program thread has been exceeded based on a cache miss rate at a cache of the processor.

16. The processor of claim 14, wherein the power control module is to:
decrease power to the memory controller in response to the performance monitor indicating the memory latency tolerance of the program thread has not been exceeded.

17. The processor of claim 14, wherein the power control module is to:
increase power to the memory controller to a first level in response to the performance monitor indicating the memory latency tolerance of the program thread has been exceeded by a first amount; and
increase power to the memory controller to a second level in response the performance monitor indicating the memory latency tolerance of the program thread has been exceeded by a second amount.

18. The processor of claim 14, wherein the power control module is to:
increase power to the memory controller to a first level in response to the memory latency tolerance of the program thread being exceeded; and
decrease power to the memory controller from the first level to a second level in response to the performance monitor indicating an instructions-per-cycle rate at a processor core of the processor is below a threshold.

19. The processor of claim 14, wherein the power control module is to:
increase power to the memory controller in response to the performance monitor indicating that a bandwidth required by the memory access requests exceeds a threshold.

20. The processor of claim 14, wherein the performance monitor indicates the memory latency tolerance of the program thread has been exceeded based on a number of memory access requests received at the memory controller.
